(19) United States
(12) Patent Application Publication
(10) Pub. No.: US 2013/0314504 A1
(43) Pub. Date: Nov. 28, 2013

(54) METHOD AND DEVICE FOR IMAGING AT LEAST ONE THREE-DIMENSIONAL COMPONENT

(71) Applicant: MTU Aero Engines GmbH, Munich (DE)

(72) Inventors: Guenter ZENZINGER, Waakirchen (DE); Wilhelm Satzger, Muenchen (DE); Joachim Bamberg, Dachau (DE); Thomas Hess, Muenchen (DE)

(21) Appl. No.: 13/900,402

(22) Filed: May 22, 2013

(30) Foreign Application Priority Data
May 25, 2012 (EP) 12169446.7

(51) Int. Cl. G06T 7/00

(52) U.S. Cl. CPC G06T 7/0004
USPC 348/46

(57) ABSTRACT

A method for imaging at least one three-dimensional component, which is produced by a generative manufacturing method, is disclosed. The method, in an embodiment, includes determining at least two layer images of the component during production thereof by a detection device, which is designed to detect with spatial resolution a measured quantity characterizing the energy input in the component. The method further includes generating a three-dimensional image of the component based on the determined layer images by a computing device and displaying the image by a display device. A device for carrying out the method is also disclosed.

This application claims the priority of European Patent Document No. EP 12169446.7, filed May 25, 2012, the disclosure of which is expressly incorporated by reference herein.

### BACKGROUND AND SUMMARY OF THE INVENTION

The invention relates to a method for imaging at least one three-dimensional component, which is produced by a generative manufacturing method. The invention further relates to a device for carrying out such a method.

A method is known from German Patent Document No. DE 10 2007 056 984 A1 in which a three-dimensional object or component is produced by laser sintering in that the component is produced by solidifying a powdery material layer-by-layer at those locations of the respective component layer corresponding to the component by laser beams. Layer images of the applied layers of powder are captured by an IR camera in order to check the individual component layers for irregularities based on temperature differences.

The disadvantage of the known method is the fact that analyzing the layer images of the component is comparatively time-consuming.

The object of the present invention is creating a method for imaging at least one component produced by a generative manufacturing method, wherein the method permits an improved evaluation of the quality of the produced component. A further object of the invention is creating a suitable device for carrying out this method.

Advantageous embodiments of the method should be viewed as advantageous embodiments of the device and vice versa.

An embodiment of a method according to the invention for imaging at least one three-dimensional component, which is produced by a generative manufacturing method comprises at least the steps of determining at least two layer images of the component during the production thereof by a detection device, which is designed to detect with spatial resolution a measured quantity characterizing the energy input in the component; generating a three-dimensional image of the component based on the determined layer images by a computing device; and displaying of the image by a display device. Therefore, it is possible by the method according to the invention to detect the energy input in the component during production thereof and record it with spatial resolution. The component may be, for example, a component for a thermal gas turbine, for an aircraft engine or the like. Because of the subsequent combination or stacking of the individual layer images, a three-dimensional image is obtained, which correspondingly characterizes the energy input at each measured point of the component. Displaying this image ultimately makes possible an especially quick, simple and precise checking and evaluation of the manufacturing quality of the component. In contrast, for example, to an ordinary x-ray examination, which is a projection method with superimposed structures, the inner structures of the component may be displayed non-destructively and without superimposition just as they would actually be after formally cutting open the component. As a further difference from a purely geometrical analysis of the component, the determination of the energy input allows an enhanced and comprehensive quality analysis of the component produced, because even geometrically inconspicuous material irregularities, erroneous process parameters of the generative manufacturing method and the like are able to be detected.

An advantageous embodiment of the invention provides that the layer images depict the entire component and/or a used construction space of the generative manufacturing method without superimposition. This allows an especially comprehensive and quick control possibility of the manufacturing method. Especially if large components and/or a plurality of components are being produced at the same time in the construction space of a generative manufacturing device used, this yields considerable savings in terms of time and costs.

Additional advantages are yielded if the component is produced by a generative layering manufacturing process, in particular by selective laser melting and/or by selective laser sintering. The use of a generative layering manufacturing process in conjunction with the superimposition-free determination of layer images of the component during its layer-by-layer production makes an especially precise evaluation of the manufacturing quality of the component possible. In addition, using the generative layering manufacturing process permits a quick and economic manufacturing of geometrically complex components in large unit numbers, which has considerable advantages in terms of time and costs especially in the production of engine components. In the case of selective laser melting, thin powder layers of the material(s) being used are applied to a manufacturing zone, and locally fused with the aid of one or more laser beams and solidified. Then the manufacturing zone is lowered, a further powder layer is applied and again locally solidified. This cycle is repeated so long until the finished component is obtained. The finished component may then be processed further as needed or used immediately. In the case of selective laser sintering, the component is produced in a similar manner by laser-supported sintering of powdery materials. The energy input in the individual component layers that occurs from the laser radiation is detected in this case as described in the foregoing in the form of at least two layer images and used to display the three-dimensional image of the component.

An especially detailed and comprehensive check of the component is achieved in another embodiment of the invention in that during the generative layering manufacturing process a layer image characterizing the energy input in the component layer is determined for each component layer.

An especially detailed quality control of the component is achieved in another embodiment of the invention in that at least one layer image is composed of a plurality of individual images, in particular of 100 to 1000 individual images and/or is composed of individual images each depicting between 0.1 cm² and 1.0 cm² of the component layer and/or is composed of individual images each depicting a width of between 0.1 mm and 0.5 mm of the component layer. In other words, it is provided according to the invention that at least one, a plurality or all layer images are each composed of a plurality of individual images, whereby the resolution of the image is advantageously increased. 0.1 cm² to 1.0 cm² of the component layer should be understood in particular as areas of 0.1 cm², 0.2 cm², 0.3 cm², 0.4 cm², 0.5 cm², 0.6 cm², 0.7 cm², 0.8 cm², 0.9 cm² or 1.0 cm² as well as corresponding intermediate values. A width of between 0.1 mm and 0.5 mm should be understood in particular as widths of 0.1 mm, 0.2 mm, 0.3 mm, 0.4 mm or 0.5 mm as well as corresponding intermediate values. In addition, it may basically be provided that the individual images have different exposure times so that the resulting layer image corresponds to a so-called “high dynamic range” image, i.e., an image with an especially high dynamic range. This makes an additionally improved control possibility of component quality possible.

A further advantageous embodiment of the invention provides that the detection device comprise a high-resolution detector and/or an IR-sensitive detector, in particular a CMOS and/or sCMOS and/or CCD sensor for detecting IR radiation as a measured quantity. This permits an especially simple, precise and cost-effective determination of the energy input. In addition, the quality of the component layer in question is able to be analyzed in an especially precise manner based on temperature differences in the determined IR layer image, because, for example, irregularities in the material, in the layer thickness or in application of heat are able to be determined and displayed especially precisely.

Another advantageous embodiment of the invention provides that an exposure time of between 1.0 ms and 5000 ms, in particular of between 50 ms and 500 ms, be set for every individual image. As a result, the determination of the layer images is able to be adjusted optimally to the generative manufacturing method used, the production parameters and the material and geometry of the component. To be understood as an exposure time of between 1.0 ms and 5000 ms in this case are in particular exposure times of 1 ms, 50 ms, 100 ms, 150 ms, 200 ms, 250 ms, 300 ms, 350 ms, 400 ms, 450 ms, 500 ms, 550 ms, 600 ms, 650 ms, 700 ms, 750 ms, 800 ms, 850 ms, 900 ms, 950 ms, 1000 ms, 1050 ms, 1100 ms, 1150 ms, 1200 ms, 1250 ms, 1300 ms, 1350 ms, 1400 ms, 1450 ms, 1500 ms, 1550 ms, 1600 ms, 1650 ms, 1700 ms, 1750 ms, 1800 ms, 1850 ms, 1900 ms, 1950 ms, 2000 ms, 2050 ms, 2100 ms, 2150 ms, 2200 ms, 2250 ms, 2300 ms, 2350 ms, 2400 ms, 2450 ms, 2500 ms, 2550 ms, 2600 ms, 2650 ms, 2700 ms, 2750 ms, 2800 ms, 2850 ms, 2900 ms, 2950 ms, 3000 ms, 3050 ms, 3100 ms, 3150 ms, 3200 ms, 3250 ms, 3300 ms, 3350 ms, 3400 ms, 3450 ms, 3500 ms, 3550 ms, 3600 ms, 3650 ms, 3700 ms, 3750 ms, 3800 ms, 3850 ms, 3900 ms, 3950 ms, 4000 ms, 4050 ms, 4100 ms, 4150 ms, 4200 ms, 4250 ms, 4300 ms, 4350 ms, 4400 ms, 4450 ms, 4500 ms, 4550 ms, 4600 ms, 4650 ms, 4700 ms, 4750 ms, 4800 ms, 4850 ms, 4900 ms, 4950 ms or 5000 ms as well as corresponding intermediate values such as e.g., 50 ms, 55 ms, 60 ms, 65 ms, 70 ms, 75 ms, 80 ms, 85 ms, 90 ms, 95 ms, 100 ms, 105 ms, 110 ms, 115 ms, 120 ms, 125 ms, 130 ms, 135 ms, 140 ms, 145 ms, 150 ms, 155 ms, 160 ms, 165 ms, 170 ms, 175 ms, 180 ms, 185 ms, 190 ms, 195 ms, 200 ms, 205 ms, 210 ms, 215 ms, 220 ms, 225 ms, 230 ms, 235 ms, 240 ms, 245 ms, 250 ms, 255 ms, 260 ms, 265 ms, 270 ms, 275 ms, 280 ms, 285 ms, 290 ms, 295 ms, 300 ms, 305 ms, 310 ms, 315 ms, 320 ms, 325 ms, 330 ms, 335 ms, 340 ms, 345 ms, 350 ms, 355 ms, 360 ms, 365 ms, 370 ms, 375 ms, 380 ms, 385 ms, 390 ms, 395 ms, 400 ms, 405 ms, 410 ms, 415 ms, 420 ms, 425 ms, 430 ms, 435 ms, 440 ms, 445 ms, 450 ms, 455 ms, 460 ms, 465 ms, 470 ms, 475 ms, 480 ms, 485 ms, 490 ms, 495 ms or 500 ms. Basically, it has been shown to be advantageous if the exposure time is set such that, on the one hand, the time window is large enough to detect the energy input, but, on the other hand, small enough to sum up no interfering background radiation or as little as possible.

Additional advantages are yielded in that the image of the component is compared with a target image of the component by the computing device. This allows for an especially simple and reliable check of whether the manufactured component is within permissible manufacturing tolerances or not. The comparison takes place in this case preferably by the computing device that is present anyhow, for example a single computer, a workstation or the like.

In another advantageous embodiment of the invention it has been shown to be advantageous if a data model and/or an x-ray image of the component and/or an image of a reference component is used as a target image. By using a data model as a target image, it is possible to carry out a check based an ideal target geometry. Through a comparison with an x-ray image of the component, it is possible to detect in particular internal defects, imperfections, foreign inclusions, powder quality, layer thickness, discontinuities, construction homogeneity in the construction space, etc., as well as the significance of these deviations from the target for the quality of the component. Moreover, it may basically be provided that the image of the component be compared with an image of a previous and/or simultaneously produced reference component.

In addition, it may basically be provided that mechanical parameter values, for example, the tensile strength and/or flexural strength in the direction of the mechanical main load axes, metallurgical examination results of imperfections, etc., be determined for the component produced and be brought into relation with the image. This permits a reliable evaluation of any deviations, defects, imperfections, etc., with respect to the quality of the component and a correspondingly improved online process control for the generative manufacturing method.

Another advantageous embodiment of the invention provides that deviations between the image and the target image be displayed by the display device. This permits an especially simple and clear quality control of the component. In this case, it may basically be provided that the deviations be displayed independently of the image and/or overlaid with the image. The image may be displayed transparently or semi-transparently, while the deviation or deviations is/are opaque. Alternatively or additionally, the deviations may naturally also be identified or emphasized in color by symbols or in another manner.

In addition, it has been shown to be advantageous if, in the event of a deviation between the image and the target image, at least one process parameter of the manufacturing method that is relevant for the deviation is varied. This makes it possible to reduce or completely prevent the formation of imperfections in future components and correspondingly improve the quality of the components produced by the generative manufacturing method.

A further aspect of the invention relates to a device for carrying out a method according to one of the preceding exemplary embodiments. The device according to the invention comprises in this case at least one generative manufacturing device for producing a component, in particular a component for an aircraft engine; a detection device, which is designed to detect with spatial resolution a measured quantity characterizing the energy input in the component during production of the component; a computing device by which a three-dimensional image of the component can be generated based on the determined layer images; and a display device by which the image of the component can be displayed. This makes an especially quick, simple and detailed check and evaluation of the manufacturing quality of the component possible. Other advantages that are yielded are found in the foregoing descriptions of the first aspect of the invention.

An advantageous embodiment of the invention provides that the generative manufacturing device comprises or is a device for selective laser melting and/or for selective laser sintering. This makes it possible for components having any three-dimensional geometry to be produced and be evaluated with respect to their manufacturing quality, the mechanical properties of which largely correspond to those of the material used. Suitable materials include, for example, metals, metal alloys such as steel, aluminum and aluminum alloys, titanium and titanium alloys, cobalt alloys and/or chromium alloys, nickel-based alloys and copper alloys as well as ceramic material and plastics.

Another advantageous embodiment of the invention provides that the detection device is disposed outside of a beam path of a laser of the manufacturing device and/or outside of a construction space of the manufacturing device. This advantageously ensures that the detection device is not situated in the beam path and that the laser does not suffer any energy losses from optical elements such as, for instance, semitransparent mirrors. In addition, the detection device therefore does not influence the production method, is simple to replace or retrofit and may also be used in a mobile manner.

Another advantageous embodiment of the invention provides that the detection device comprise an IR-sensitive sCMOS camera. Sensors with this design are in a position to replace most available CCD image sensors. In comparison to previous generations of CCD-based and/or CMOS-based sensors or cameras, cameras based on sCMOS sensors offer different advantages such as, e.g., a very low readout noise, a high frame rate, a large dynamic range, a high quantum efficiency, and a high resolution along with a very large sensor surface. This makes possible an especially good quality testing of the component produced.

Additional features of the invention are disclosed in the exemplary embodiments and the drawings. The features and combinations of features cited in the foregoing description and the features and combinations of features cited in the following exemplary embodiments are useable not only in the respectively indicated combination, but also in other combinations without leaving the scope of the invention.

### BRIEF DESCRIPTION OF THE DRAWINGS

FIG. 1 is a sectional perspective view of a device according to the invention, which comprises a generative manufacturing device, on which an IR-sensitive sCMOS camera is disposed as a detection device;

FIG. 2 is a lateral schematic diagram of the manufacturing device shown in FIG. 1;

FIG. 3 is a layer image of several components produced in a construction space of the manufacturing device;

FIG. 4 is an enlarged representation of Detail IV shown in FIG. 3;

FIG. 5 is a three-dimensional image of the components produced in the construction space of the manufacturing device; and

FIG. 6 is a perspective representation of the three-dimensional image of a component, wherein, in addition, deviations between the image and a target image of the component are identified.

### DETAILED DESCRIPTION OF THE DRAWINGS

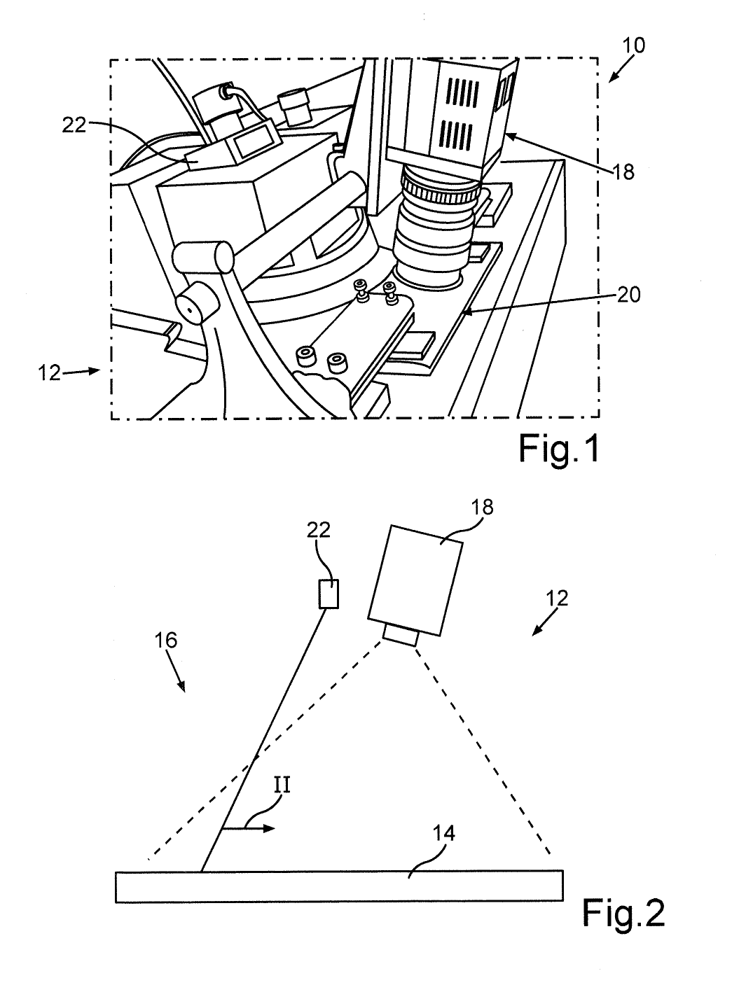

FIG. 1 shows a sectional perspective view of a device 10 according to the invention which comprises a generative manufacturing device 12 for producing a component 14 for an aircraft engine. The generative manufacturing device 12 itself is configured in this case as a selective laser melting (SLM) system that is known per se. FIG. 1 will be explained in the following in conjunction with FIG. 2, in which a lateral schematic diagram of the manufacturing device 12 shown in FIG. 1 is depicted. One can see that a detection device 18 is disposed outside of a construction space 16 of the manufacturing device 12, the detection device being designed to detect as a layer image with spatial resolution a measured quantity characterizing the energy input in the component 14 during production of the component 14. In the present case, the detection device 18 comprises an IR-sensitive sCMOS camera with 5.5 megapixels and a refresh rate of 100 Hz. Although in principle other types of sensors, black-and-white cameras or the like may also be used, a color sensor or a sensor with a broad spectral range supplies comparatively more information, which permits a correspondingly more precise evaluation of the component 14. A laser protective glass 20 is disposed between the construction space 16 and the detection device 18 in order to prevent damage to the sCMOS sensor of the camera from a laser 22 of the manufacturing device 12. Therefore, the detection device 18 is situated outside of the construction space 16 and outside of the beam path II of the laser 22 of the manufacturing device 12. This advantageously ensures that the detection device 18 is not situated in the beam path II and that the laser 22 does not correspondingly suffer any energy losses from optical elements such as semitransparent mirrors, optical diffraction grating or the like. In addition, the detection device 18 does not influence the production method of the component 14 and is also simple to replace or retrofit.

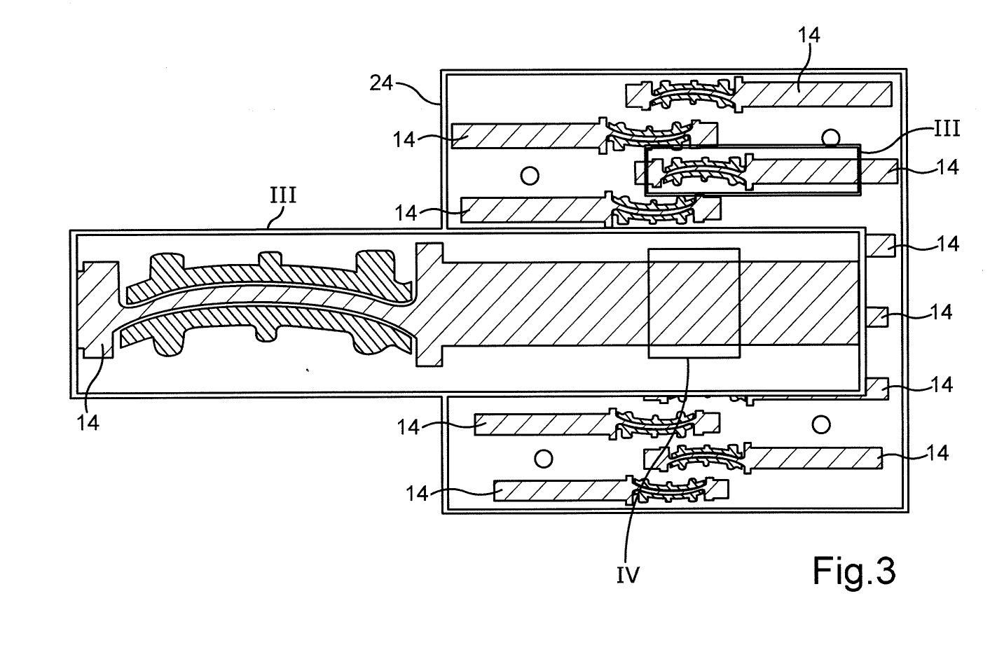

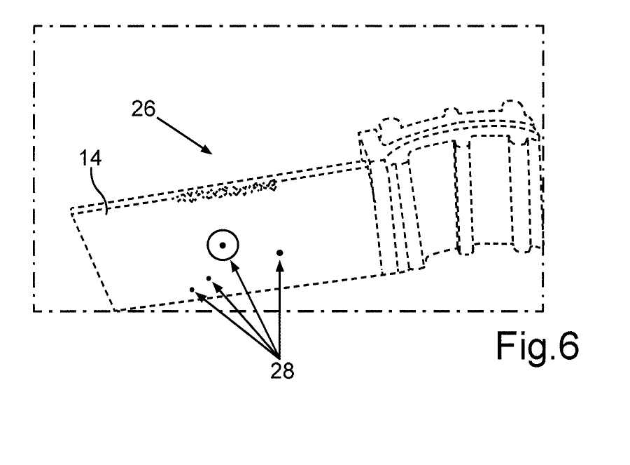

To produce the component 14, which is configured here as a rotor blade, thin powder layers of a high-temperature-proof metal alloy are applied in a manner that is known per se on a platform (not shown) of the manufacturing device 12, and locally fused by the laser 22 and solidified by cooling. Then the platform is lowered, another powder layer is applied and again solidified. This cycle is repeated so long until the component 14 is produced. The component 14 may be made of, for example, up to 2000 component layers or have an overall layer height of 40 mm. The finished component 14 may then be processed further or used immediately. The energy input in the individual component layers from the laser radiation is determined in this case for each component layer with the aid of the detection device 18 as a thermographic layer image 24 (see FIG. 3). After completion of the component 14, the individual layer images (tomograms) are merged together into an image 26 (see FIG. 5 and FIG. 6) of the component 14 in accordance with a type of computer tomography by a computing device (not shown). The thermographic measured quantities and if applicable other information derived herefrom are then visualized with spatial resolution by a display device (not shown) in the form of the image 26 and, for example, coded via brightness values and/or colors.

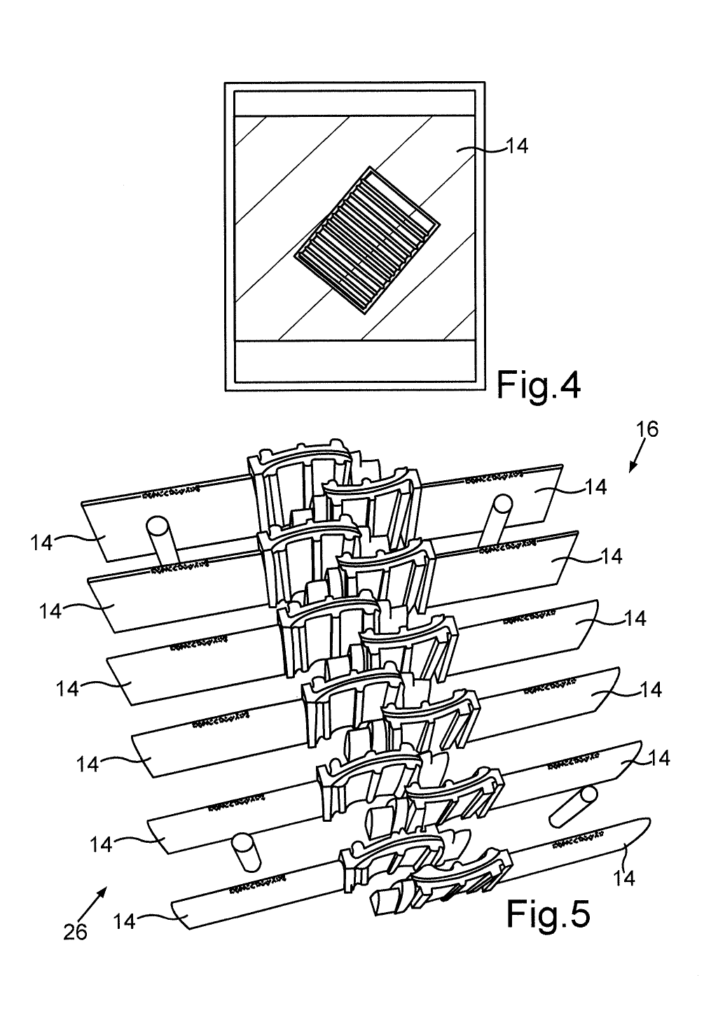

FIG. 3 depicts by way of example a layer image 24 of several components 14, which are being jointly produced in the construction space 16 of the manufacturing device 12. One can see that the layer image 24 depicts the entire construction space 16 without any overlapping. Reference number III identifies an enlarged detail of one of the components 14. In addition, FIG. 4 shows an additional enlargement of Detail IV. One can see that not just geometric information, but also information about the local temperature distribution in the computer layer in question and therefore about the energy input in the individual weld path during the SLM process is obtained through the optical thermography. It may basically be provided that the layer image 24 be composed of a plurality of individual images. For example, depending upon the area of the construction space 16, the layer image 24 may be composed of up to 1000 individual images or more per component layer or be composed of individual images each depicting between 0.1 cm² and 1.0 cm² of the individual component layers. Depending upon the need, the exposure time per image is between 1 ms and 5000 ms, preferably between 50 ms and 500 ms. Basically it may be provided that the distance covered by the laser beam per individual image be between 10 mm and 120 mm, that is, for example 10 mm, 20 mm, 30 mm, 40 mm, 50 mm, 60 mm, 70 mm, 80 mm, 90 mm, 100 mm, 110 mm or 120 mm. Furthermore, it may basically be provided that each layer image 24 be detected within 2 minutes in order to avoid too much cooling of the component layers and the loss of information that is associated with this.

FIG. 5 depicts the three-dimensional image 26 of the components 14 jointly produced in the construction space 16 of the manufacturing device 12. The image 26 was generated with the aid of a computing device formally by stacking the individual layer images 24 into an image stack and is displayed by a suitable display device (not shown), for example a monitor. For a better check of component qualities it may basically be provided that the display of the image 26 can be manipulated and the image 26 may be displayed as, for example, rotated, enlarged, reduced, displaced, in different colors or as a wireframe model. In addition, it may be provided that specific regions of the image 26, for example individual components 14, may be shown or hidden.

FIG. 6 shows a perspective representation of the three-dimensional image 26 of a component 14, wherein, in addition, deviations 28 between the image 26 and a target image of the component 14 are identified with spatial resolution. For this purpose, the image 26 of the component 14 is displayed in a semi-transparent manner, while the deviations 28 are displayed opaquely and if need be may also be identified by additional symbols such as circles or the like. This makes an especially quick and reliable evaluation of the manufacturing quality of the component 14 possible. The deviations 28 may arise, for example, from internal defects, imperfections, discontinuities, foreign inclusions or from fluctuations in the powder quality, powder layer thickness or other inhomogeneities in the construction space 16. If the component 14 is outside of its manufacturing tolerances because of the deviations 28 that are present, at least one process parameter of the manufacturing method that is relevant for the deviations 28 is varied in such a way that the deviations 28 are reduced or as much as possible completely prevented during the production of additional components 14.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for imaging a component, which is produced by a generative manufacturing method, comprising the steps of:
determining at least two layer images of the component during production of the component by a detection device, wherein a measured quantity characterizing energy input in the component is detected with spatial resolution by the detection device for each of the at least two layer images;
generating a three-dimensional image of the component based on the determined at least two layer images by a computing device; and
displaying the three-dimensional image by a display device.

2. The method according to claim 1, wherein the at least two layer images depict an entirety of the component.

3. The method according to claim 1, wherein the component is produced by a generative layering manufacturing process.

4. The method according to claim 3, wherein the generative layering manufacturing process is selective laser melting or selective laser sintering.

5. The method according to claim 3, wherein a layer image is determined for each component layer.

6. The method according to claim 1, wherein at least one layer image of the at least two layer images is composed of a plurality of individual images or is composed of individual images each depicting between 0.1 cm² and 1.0 cm² of a component layer or is composed of individual images each depicting a width of between 0.1 mm and 0.5 mm of the component layer.

7. The method according to claim 1, wherein the detection device is a high-resolution detector or an IR-sensitive detector.

8. The method according to claim 1, wherein the detection device is a CMOS sensor or a sCMOS sensor or a CCD sensor.

9. The method according to claim 6, wherein an exposure time of between 1.0 ms and 5000 ms is set for the plurality of individual images.

10. The method according to claim 1, further comprising the step of comparing the three-dimensional image of the component with a target image of the component by the computing device.

11. The method according to claim 10, wherein a data model or an x-ray image of the component or an image of a reference component is the target image.

12. The method according to claim 10, wherein deviations between the three-dimensional image and the target image are displayed by the display device.

13. The method according to claim 10, wherein in an event of a deviation between the three-dimensional image and the target image, at least one process parameter of the manufacturing method that is relevant for the deviation is varied.

14. A device for imaging a component, comprising:
a generative manufacturing device, wherein the component is produced by the generative manufacturing device;
a detection device, wherein at least two layer images of the component during production of the component are determinable by the detection device and wherein a measured quantity characterizing energy input in the component is detectable with spatial resolution by the detection device for each of the at least two layer images;
a computing device, wherein a three-dimensional image of the component based on the determined at least two layer images is generatable by the computing device; and
a display device, wherein the three-dimensional image is displayable by the display device.

15. The device according to claim 14, wherein the generative manufacturing device is a device for selective laser melting or for selective laser sintering.

16. The device according to claim 14, wherein the detection device is disposed outside a beam path of a laser of the generative manufacturing device or outside a construction space of the generative manufacturing device.

17. The device according to claim 14, wherein the detection device is an IR-sensitive sCMOS camera.

18. The device according to claim 14, wherein the component is a component for an aircraft engine.

19. A method for imaging a component, comprising the steps of:
detecting energy input in at least two layers of the component during production of the component by a detection device;
generating respective layer images of the at least two layers of the component by the detection device, wherein the respective layer images include the detected energy input;
generating a three-dimensional image of the component based on the respective layer images by a computing device; and
displaying the three-dimensional image by a display device.

20. The method according to claim 19, further comprising the step of comparing the three-dimensional image with a target image of the component by the computing device.
